(19) United States
(12) Patent Application Publication
(10) Pub. No.: US 2025/0329854 A1
(43) Pub. Date: Oct. 23, 2025

(54) CONDUCTIVE MODULE

(71) Applicants: YAZAKI CORPORATION, Tokyo (JP); TOYOTA JIDOSHA KABUSHIKI KAISHA, Toyota-shi (JP)

(72) Inventors: Ryota Ando, Makinohara-shi (JP); Kaname Tsukamoto, Toyota-shi (JP)

(21) Appl. No.: 19/169,013

(22) Filed: Apr. 3, 2025

(30) Foreign Application Priority Data
Apr. 18, 2024 (JP) 2024-067264

(51) Int. Cl. H01M 50/271; H01M 50/209; H01M 50/507; H01M 50/519

(52) U.S. Cl. CPC H01M 50/271; H01M 50/209; H01M 50/507; H01M 50/519; H01M 2220/20

(57) ABSTRACT

A circuit collection portion includes a connector connection portion, a via hole installation portion, and a positional deviation absorption portion that absorbs positional deviation in an arrangement direction of the connector between the connector connection portion and the via hole installation portion, the circuit cover member includes a cover body that covers the main line portion from a front surface at an assembly completion position, and a via hole cover portion that presses a front surface of the via hole installation portion at the assembly completion position, and intersects the via hole installation portion such that an angle on an inner side of bending with respect to the two main line portions is an obtuse angle, and the via hole cover portion is inclined at the angle with respect to the cover body.

### CROSS-REFERENCE TO RELATED APPLICATION(S)

The present application claims priority to and incorporates by reference the entire contents of Japanese Patent Application No. 2024-067264 filed in Japan on Apr. 18, 2024.

### BACKGROUND OF THE INVENTION

### 1. Field of the Invention

The present invention relates to a conductive module.

### 2. Description of the Related Art

The conductive module electrically connects a plurality of battery cells using a plurality of bus bars in a battery module in which the plurality of battery cells is arranged in a row along an arrangement direction. Then, the conductive module electrically connects each bus bar to a battery monitoring unit via a flat circuit conductor component provided with a circuit conductor for each bus bar and having flexibility. The circuit conductor component is, for example, a flexible printed circuit board including a sheet-shaped insulating layer and a conductor layer provided with a plurality of circuit conductors, and is housed in a housing member together with the bus bar and covered with a circuit cover member. This type of conductive module is disclosed in, for example, JP 2022-173 609 A.

Incidentally, in some battery modules, respective electrode terminals of a plurality of battery cells are arranged in a row on the same plane along an arrangement direction, and a smoke exhaust duct is provided between electrode terminal groups of the two rows. In this case, in the conventional conductive module, the circuit conductor component closes the smoke exhaust duct. For this reason, as the circuit conductor component, a circuit conductor component is used that includes a main line portion that is provided to extend in the arrangement direction for each electrode terminal group and in which a circuit conductor for each bus bar connected to each electrode terminal of the electrode terminal group is wired, and a circuit collection portion in which respective ends in the arrangement direction of two main line portions avoiding the smoke exhaust duct are coupled to each other, and the plurality of circuit conductors of both main line portions is collected at one place. Here, the circuit collection portion includes a via hole setting portion having a plurality of via holes, a connector connection portion to which a connector for electrically connecting the circuit conductor to the battery monitoring unit is assembled, and a positional deviation absorption portion that is flexurally deformed to absorb positional deviation of the connector with respect to a counterpart connector. In this circuit collection portion, when the force associated with the flexural deformation of the positional deviation absorption portion is transmitted to the via hole setting portion, an unnecessary force acts on the via holes of the via hole setting portion, which is not preferable.

### SUMMARY OF THE INVENTION

Therefore, an object of the present invention is to provide a conductive module suitable for circuit protection.

In order to achieve the above mentioned object, a conductive module according to one aspect of the present invention includes a plurality of bus bars that electrically connects a plurality of battery cells arranged in a row along an arrangement direction in a battery module; a circuit conductor component that includes a circuit conductor for each of the bus bars that electrically connects the bus bar to a battery monitoring unit, the circuit conductor component being formed flat with flexibility; a housing member that houses the bus bar and the circuit conductor component through an opening; and a circuit cover member that is assembled to the housing member at an assembly completion position and covers the circuit conductor component from an opening side, wherein the circuit conductor component includes two main line portions disposed to face each other with a space in a direction orthogonal to the arrangement direction on a same plane, and a circuit collection portion in which the respective circuit conductors of the two main line portions are collected at one place by coupling respective ends in the arrangement direction of the two main line portions, the circuit collection portion includes a connector connection portion to which a connector is assembled at an end on a side opposite to a two main line portions side, a via hole installation portion provided with a plurality of via holes on the two main line portions side, and a positional deviation absorption portion that absorbs positional deviation in the arrangement direction of the connector with respect to a counterpart connector on a battery monitoring unit side between the connector connection portion and the via hole installation portion, the circuit cover member includes a cover body that covers the main line portion from a front surface at the assembly completion position, and a via hole cover portion that presses a front surface of the via hole installation portion at the assembly completion position, and intersects the via hole installation portion such that an angle on an inner side of bending with respect to the two main line portions is an obtuse angle, and the via hole cover portion is inclined at the angle with respect to the cover body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is an exploded perspective view illustrating the conductive module according to the embodiment;

FIG. 3 is a perspective view extracting a part of the conductive module from which a cover member is removed;

FIG. 4 is a partially enlarged view taken along line X-X in FIG. 3;

FIG. 5 is a schematic view illustrating a battery module together with bus bars;

FIG. 6 is a perspective view illustrating a main part of the circuit conductor component;

FIG. 7 is a perspective view illustrating a main part of a circuit cover member; and

FIG. 8 is a perspective view illustrating a main part of a housing member.

### DETAILED DESCRIPTION OF THE PREFERRED EMBODIMENTS

Hereinafter, an embodiment of a conductive module according to the present invention will be described in detail with reference to the drawings. Note that this invention is not limited by this embodiment.

### Embodiment

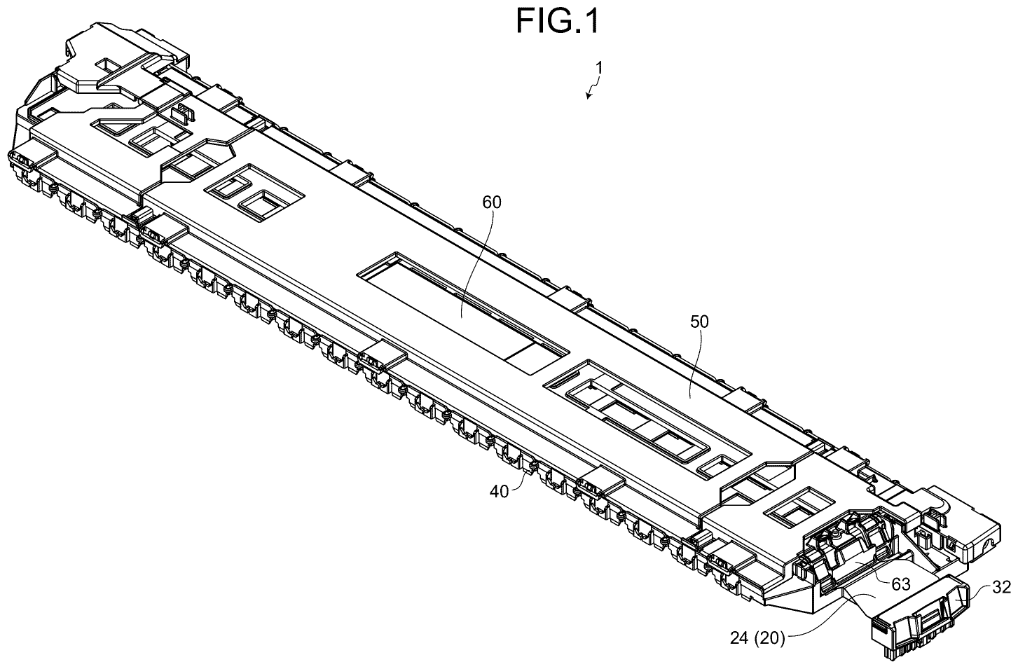

One embodiment of the conductive module according to the present invention will be described with reference to FIGS. 1 to 8.

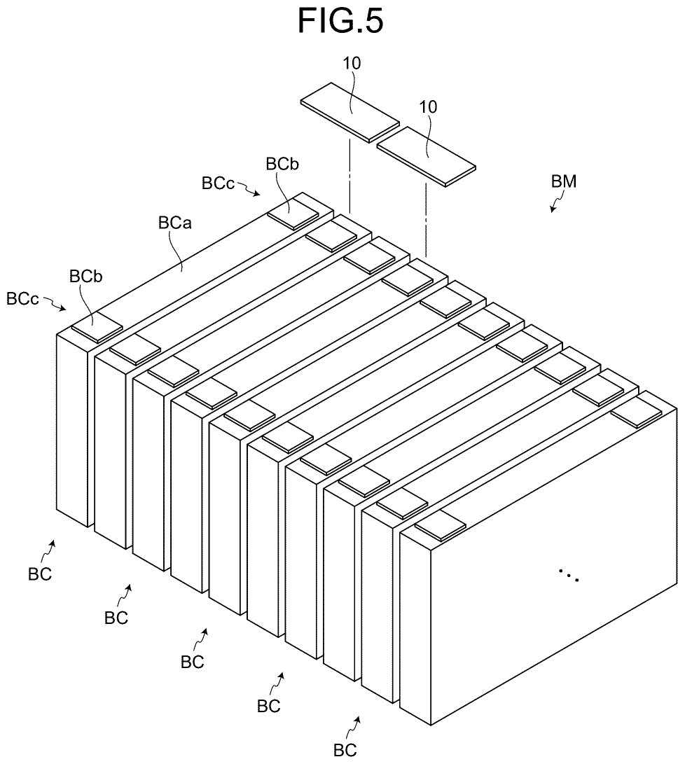

Reference numeral 1 in FIGS. 1 to 4 denotes a conductive module of the present embodiment. The conductive module 1 is assembled to a battery module BM (FIG. 5) in which a plurality of battery cells BC is arranged in a row along an arrangement direction, and electrically connects the plurality of battery cells BC in the battery module BM. In addition, the conductive module 1 electrically connects the battery module BM to a battery monitoring unit (illustration omitted) to cause the battery monitoring unit to monitor the battery state of the battery cells BC. The conductive module 1 constitutes a battery pack together with the battery module BM. The battery pack is mounted on, for example, a vehicle (battery electric vehicle (BEV), hybrid electric vehicle (HEV), or the like) including a rotary machine as a drive source, and is used for power supply to the rotary machine.

The battery cell BC includes a cell body BCa and positive and negative electrode terminals BCb (FIG. 5). In the battery cell BC illustrated here, the cell body BCa is formed in a rectangular parallelepiped shape having six outer wall surfaces. Then, in the plurality of battery cells BC constituting the battery module BM, the cell bodies BCa adjacent to each other in the arrangement direction are disposed with one outer wall surface facing each other. The battery module BM includes one electrode terminal group BCc in which electrode terminals BCb of the respective battery cells BC on one side are arranged along the arrangement direction, and the other electrode terminal group BCc in which electrode terminals BCb of the respective battery cells BC on the other side are arranged along the arrangement direction (FIG. 5).

Hereinafter, when the term “arrangement direction” is described without particular reference, it refers to the arrangement direction of the plurality of battery cells BC or the arrangement direction of the plurality of electrode terminals BCb in the electrode terminal group BCc.

In this example, each battery cell BC includes positive and negative electrode terminals BCb on one of the six outer wall surfaces of the cell body BCa (FIG. 5). Therefore, in the battery module BM, two electrode terminal groups BCc are provided at an interval on the same plane (FIG. 5). In the battery module BM, an exhaust duct for discharging the gas discharged from the inside of the battery cells BC to the outside is provided (illustration omitted) between the two electrode terminal groups BCc.

In addition, the electrode terminals BCb illustrated here are formed in a flat plate shape, and physically and electrically connect bus bars 10 to be described below by welding or the like (FIG. 5). However, the electrode terminals BCb may be formed in a pole shape having a male screw portion. In this case, the bus bar 10 is fixedly screwed to the electrode terminal BCb by screwing a female screw member to the male screw portion of the electrode terminal BCb.

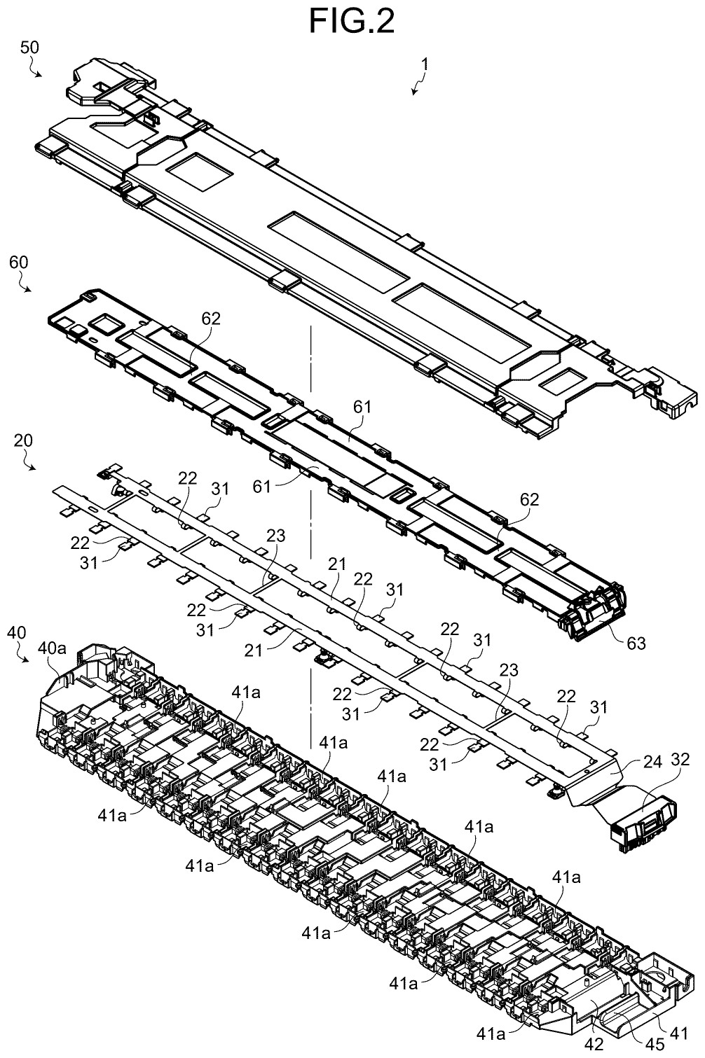

The conductive module 1 includes a plurality of bus bars 10 electrically connecting the plurality of battery cells BC of the battery module BM (FIG. 5). Then, the conductive module 1 includes a circuit conductor component 20 that includes a circuit conductor for each bus bar 10 that electrically connects the bus bar 10 to the battery monitoring unit, and is formed flat with flexibility (FIGS. 1 to 4). The conductive module 1 of the present embodiment further includes a terminal fitting 31 for each bus bar 10 that electrically connects the circuit conductor to the bus bar 10, which is a connection target (FIG. 2). The conductive module 1 includes a housing member 40 that houses the bus bar 10 and the circuit conductor component 20 through an opening 40a (FIGS. 1 to 4). The conductive module 1 includes a cover member 50 that is assembled to the housing member 40 and closes the opening 40a (FIGS. 1 and 2). Furthermore, the conductive module 1 includes a circuit cover member 60 that is assembled to the housing member 40 at an assembly completion position, is interposed between the circuit conductor component 20 and the cover member 50, and covers the circuit conductor component 20 from an opening 40a side (FIGS. 1 to 4). Here, for example, the terminal fitting 31 for each bus bar 10 is attached in advance to the circuit conductor component 20, and the circuit conductor component 20 with the terminal fittings 31 is housed in the housing member 40.

The bus bar 10 and the terminal fitting 31 are molded of a conductive material such as metal. The circuit conductor component 20 is made of a conductive material such as metal and an insulating material such as synthetic resin. The housing member 40, the cover member 50, and the circuit cover member 60 are molded of an insulating material such as synthetic resin.

The bus bar 10 is a plate-shaped conductive component made of metal, and is press-molded using, for example, a metal plate as a base material. The bus bar 10 illustrated here is molded in a rectangular flat plate shape.

The conductive module 1 includes, as the bus bars 10, for example, one that is physically and electrically connected to the adjacent electrode terminals BCb of a pair of battery cells BC of the battery module BM, one that is physically and electrically connected to the electrode terminal BCb serving as the total negative electrode of the battery module BM, and one that is physically and electrically connected to the electrode terminal BCb serving as the total positive electrode of the battery module BM.

As the circuit conductor component 20, for example, a flexible printed circuit board (FPC) on which a conductor pattern as a circuit conductor is formed for each bus bar 10 is used.

The circuit conductor component 20 includes two main line portions 21 disposed to face each other with a space therebetween in a direction orthogonal to the arrangement direction on the same plane (FIGS. 2, 4, and 6). The two main line portions 21 extend in the arrangement direction. The one electrode terminal group BCc and the respective electrode terminals BCb of the one electrode terminal group BCc are set along the plurality of bus bars 10, which are connection targets, and the one main line portion 21 is disposed side by side with respect thereto on an exhaust duct side of the battery module BM. In the one main line portion 21, a circuit conductor for each of the plurality of bus bars 10 related to the one electrode terminal group BCc is wired along the arrangement direction. The other electrode terminal group BCc and the respective electrode terminals BCb of the other electrode terminal group BCc are set along the plurality of bus bars 10, which are connection targets, and the other main line portion 21 is disposed side by side with respect thereto on the exhaust duct side of the battery module BM. In the other main line portion 21, a circuit conductor for each of the plurality of bus bars 10 related to the other electrode terminal group BCc is wired along the arrangement direction.

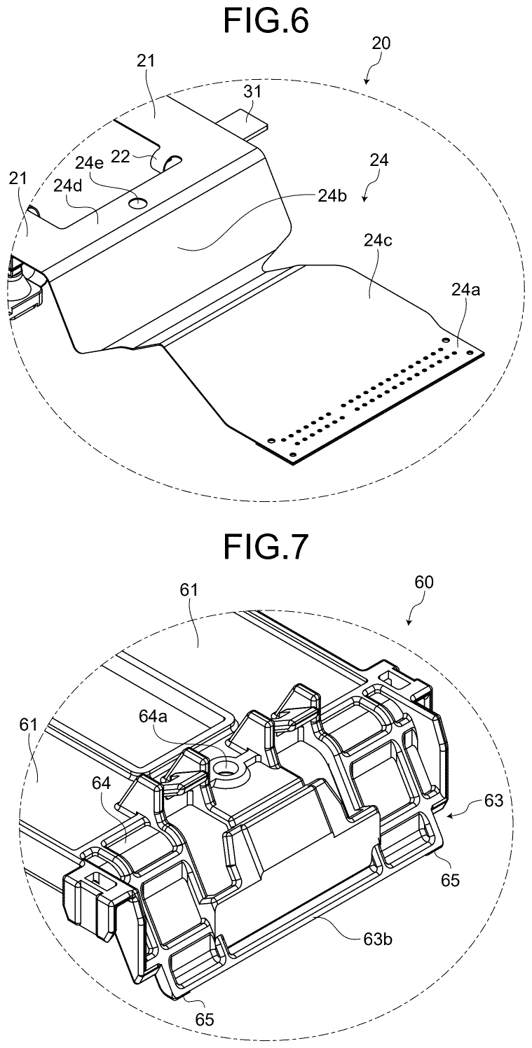

Further, the circuit conductor component 20 includes a branch portion 22 obtained by branching the circuit conductor for each bus bar 10 from the main line portion 21 (FIGS. 2 and 6). The branch portion 22 is provided on each of the one main line portion 21 side and the other main line portion 21 side. The terminal fitting 31 is provided for each branch portion 22, and is physically and electrically connected to the circuit conductor at the tip of the branch portion 22 by welding or the like. In addition, the terminal fitting 31 is physically and electrically connected to the bus bar 10 by welding or the like.

In the circuit conductor component 20, the one main line portion 21 and the other main line portion 21 are connected by body coupling portions 23 at a position avoiding the exhaust duct of the battery module BM (FIG. 2). One or a plurality of the body coupling portions 23 are provided depending on the length of the main line portion 21 in the arrangement direction.

Further, the circuit conductor component 20 includes a circuit collection portion 24 in which the respective circuit conductors of the two main line portions 21 are collected at one place by coupling the respective ends in the arrangement direction of the two main line portions 21 (FIGS. 2 to 4 and 6). In the circuit conductor component 20, the circuit collection portion 24 is electrically connected to the battery monitoring unit. Note that, for convenience of description, the circuit collection portion 24 illustrated in FIGS. 2 and 6 represents a state of being bent by the housing member 40 and the circuit cover member 60 as described below.

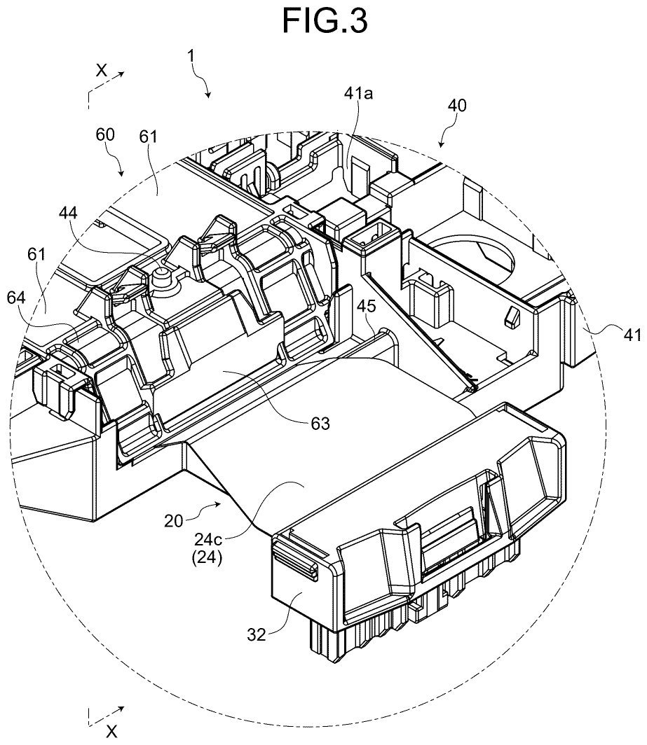

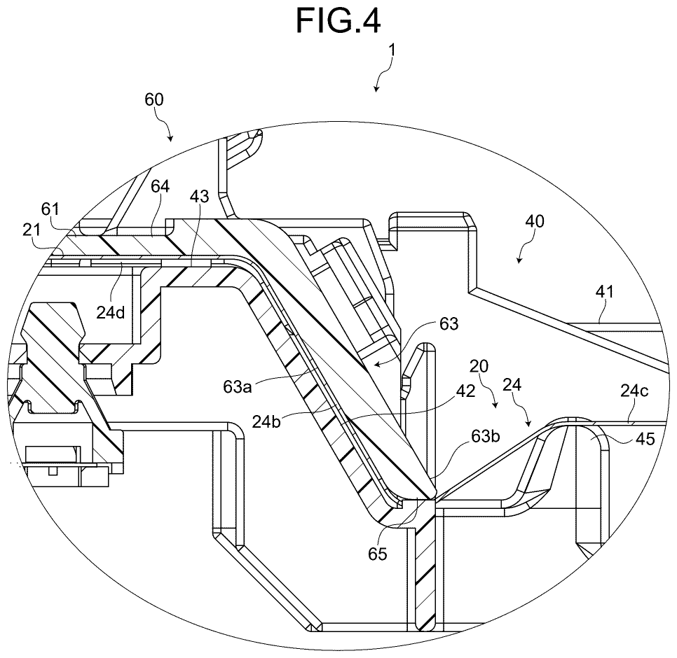

The circuit collection portion 24 includes a connector connection portion 24a to which a connector 32 (FIGS. 1 to 3) is assembled at an end on a side opposite to the two main line portions 21 side, and a via hole installation portion 24b provided with a plurality of via holes on the two main line portions 21 side (FIGS. 4 and 6). Then, the circuit collection portion 24 includes a positional deviation absorption portion 24c that absorbs positional deviation in the arrangement direction of the connector 32 with respect to a counterpart connector (illustration omitted) on the battery monitoring unit side between the connector connection portion 24a and the via hole installation portion 24b (FIGS. 3, 4, and 6). Further, the circuit collection portion 24 includes a coupling portion 24d in which an end in the arrangement direction of the one main line portion 21, an end in the arrangement direction of the other main line portion 21, and the via hole installation portion 24b are coupled on the same plane as that of the main line portions 21 (FIGS. 4 and 6). In the circuit collection portion 24, the coupling portion 24d, the via hole installation portion 24b, the positional deviation absorption portion 24c, and the connector connection portion 24a are arranged in this order in the arrangement direction.

In the circuit conductor component 20, the two main line portions 21, the branch portions 22, the body coupling portions 23, and the circuit collection portion 24 are formed on the same plane. When the circuit conductor component 20 is housed in the housing member 40 and covered with the circuit cover member 60 and the cover member 50, each branch portion 22 is bent toward the bus bar 10, and the circuit collection portion 24 is also bent.

In the conductive module 1, the bus bar 10 is housed in each bus bar housing chamber 41a (FIGS. 2 and 3) of a main body 41 of the housing member 40, the terminal fitting 31 attached to the circuit conductor component 20 is placed on the bus bar 10, and the bus bar 10 and the terminal fitting 31 are physically and electrically connected by welding or the like for each bus bar 10. The circuit conductor component 20 is housed in the housing member 40 while bending each branch portion 22, and is covered with the circuit cover member 60 assembled to the housing member 40. The conductive module 1 is installed on the battery module BM. In the conductive module 1, the cover member 50 is assembled to the housing member 40 after the bus bar 10 and the electrode terminal BCb are physically and electrically connected by welding or the like.

In the circuit conductor component 20, the circuit collection portion 24 is bent by the housing member 40 and the circuit cover member 60 by assembling the housing member 40 and the circuit cover member 60. Therefore, here, the housing member 40 and the circuit cover member 60 are formed as described below.

The circuit cover member 60 includes cover bodies 61 that cover the main line portions 21 from the front surfaces at the assembly completion position with respect to the housing member 40 (FIGS. 2 to 4 and 7). The cover body 61 is formed in a shape along the arrangement direction. In addition, the cover body 61 is provided for each main line portion 21.

In the circuit cover member 60, one cover body 61 and the other cover body 61 are connected by coupling portions 62 at a position avoiding the exhaust duct of the battery module BM (FIG. 2). One or a plurality of the coupling portions 62 are provided depending on the length of the cover body 61 in the arrangement direction.

This circuit cover member 60 includes a via hole cover portion 63 that covers the via hole installation portion 24b from the front surface at the assembly completion position with respect to the housing member 40 (FIGS. 2 to 4 and 7). The via hole cover portion 63 presses the front surface of the via hole installation portion 24b at the assembly completion position with respect to the housing member 40, and intersects the via hole installation portion 24b such that an angle on the inner side of the bending with respect to the two main line portions 21 is an obtuse angle. The via hole cover portion 63 is formed in a cantilever shape inclined at the angle with respect to the cover body 61. The via hole cover portion 63 includes a pressing surface 63a having the inclination angle, and causes a pressing force to be acted from the pressing surface 63a to the front surface of the via hole installation portion 24b (FIG. 4).

In addition, the circuit cover member 60 includes a coupling cover portion 64 that couples the ends in the arrangement direction of the two cover bodies 61 and covers the coupling portion 24d from the front surface at the assembly completion position with respect to the housing member 40 (FIGS. 3 and 4).

In the conductive module 1, the via hole installation portion 24b is covered from the front surface in a state of being inclined at the aforementioned obtuse angle with respect to the two main line portions 21 and the coupling portion 24d by the via hole cover portion 63 of the circuit cover member 60. Therefore, in this conductive module 1, the via hole installation portion 24b can be covered and protected by the via hole cover portion 63 in a state where the load acting on the via hole installation portion 24b is reduced.

For example, the circuit cover member 60 is assembled to the housing member 40 along an assembly path orthogonal to the arrangement direction and the facing disposition direction of the two main line portions 21. Therefore, in the conductive module 1, when the circuit cover member 60 is assembled to the housing member 40, the via hole installation portion 24b is pressed from the front surface by the via hole cover portion 63 to the assembly completion position, but the pressing force can be reduced. Accordingly, in the conductive module 1, when the circuit cover member 60 is assembled to the housing member 40 (in other words, when the circuit collection portion 24 is bent between the via hole installation portion 24b and the coupling portion 24d), the load acting on the via hole installation portion 24b can be reduced.

In addition, in the conductive module 1, since the via hole cover portion 63 is inclined at the aforementioned obtuse angle with respect to the cover bodies 61, the area that can be pressed against the via hole installation portion 24b by the via hole cover portion 63 can be increased as compared with the case where the via hole cover portion is bent at a right angle with respect to the cover bodies 61.

Here, the housing member 40 includes a facing disposition surface (hereinafter, referred to as a “first facing disposition surface”) 42 disposed parallel to the via hole cover portion 63 of the circuit cover member 60 at the assembly completion position and facing the back surface of the via hole installation portion 24b between the housing member 40 and the via hole cover portion 63 (FIGS. 2, 4, and 8).

In addition, the circuit cover member 60 includes a contact protrusion 65 that protrudes from a free end 63b of the via hole cover portion 63 and contacts the housing member 40 at the assembly completion position to dispose the circuit collection portion 24 between the free end 63b of the via hole cover portion 63 and the housing member 40 with a gap therebetween (FIGS. 4 and 7). Here, one contact protrusion 65 is provided at each end of the free end 63b of the via hole cover portion 63 in the facing disposition direction of the two main line portions 21. Then, here, between the two contact protrusions 65 and between the free end 63b of the via hole cover portion 63 and the housing member 40, an end of the via hole installation portion 24b on the positional deviation absorption portion 24c side is disposed. In the circuit collection portion 24, when a force is acted on the end of the via hole installation portion 24b from the positional deviation absorption portion 24c side, the force can be released to the first facing disposition surface 42 side, so that the load acting on the via hole installation portion 24b can be reduced.

On the other hand, it is desirable that when a force acts on the end of the via hole installation portion 24b on the positional deviation absorption portion 24c side from the positional deviation absorption portion 24c side, the back surface of the end is locked to the first facing disposition surface 42. Here, the back surface of the end of the via hole installation portion 24b is locked to the first facing disposition surface 42 so that an excessive load does not act on the via hole installation portion 24b by the force from the positional deviation absorption portion 24c side. Therefore, the first facing disposition surface 42 is disposed to face the back surface of the via hole installation portion 24b with a minute gap.

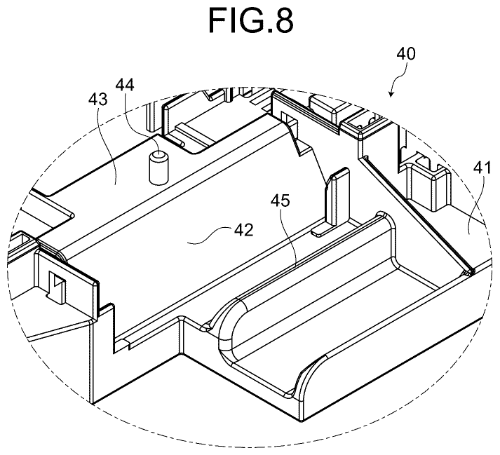

In addition, the housing member 40 includes a facing disposition surface (hereinafter, referred to as a “second facing disposition surface”) 43 that is formed in parallel with the coupling portion 24d and disposed to face the back surface of the coupling portion 24d (FIGS. 4 and 8). Then, the housing member 40 includes a positioning projection 44 placed vertically from the second facing disposition surface 43 (FIGS. 3 and 8). The coupling portion 24d includes a through-hole 24e through which the positioning projection 44 is inserted (FIG. 6). The circuit conductor component 20 can be positioned when housed in the housing member 40 by inserting the positioning projection 44 into the through-hole 24e. In addition, the coupling cover portion 64 includes a fitting portion 64a into which the positioning projection 44 is fitted (FIG. 7). The circuit cover member 60 can be positioned when assembled to the housing member 40 by fitting the positioning projection 44 into the fitting portion 64a.

In addition, the housing member 40 is provided with a locking protrusion 45 that protrudes to the opening 40a side with respect to the free end 63b of the via hole cover portion 63 at the assembly completion position, locks the positional deviation absorption portion 24c at the tip on a protruding direction side, and bends the positional deviation absorption portion 24c separately to the connector connection portion 24a side and the via hole installation portion 24b side (FIGS. 2 to 4 and 8).

In the circuit collection portion 24, a boundary portion between the via hole installation portion 24b and the positional deviation absorption portion 24c is bent with the free end 63b of the via hole cover portion 63 at the assembly completion position as a starting point, and the via hole installation portion 24b side of the positional deviation absorption portion 24c is inclined toward the tip of the locking protrusion 45. As a result, in the circuit collection portion 24, the via hole installation portion 24b and the via hole installation portion 24b side of the positional deviation absorption portion 24c are formed in a V shape.

In the circuit collection portion 24 illustrated here, the connector connection portion 24a side of the positional deviation absorption portion 24c bent by the tip of the locking protrusion 45 is extended in the arrangement direction, and the connector 32 is assembled at the connector connection portion 24a on the tip side.

As described above, in the conductive module 1 of the present embodiment, since the load acting on the via hole installation portion 24b can be reduced by the via hole cover portion 63 of the circuit cover member 60, the durability of the via hole installation portion 24b can be improved. Accordingly, the conductive module 1 of the present embodiment can not only cover the via hole installation portion 24b with the via hole cover portion 63 to protect the via hole installation portion 24b from the outside, but also protect the via hole installation portion 24b as a result of improvement in durability, and is suitable for protecting the circuit of the circuit conductor component 20.

In the conductive module according to the present embodiment, a via hole installation portion is covered from the front surface in a state of being inclined at the aforementioned obtuse angle with respect to two main line portions by a via hole cover portion of a circuit cover member. Therefore, in this conductive module, the via hole installation portion can be covered and protected by the via hole cover portion in a state where the load acting on the via hole installation portion is reduced. The conductive module can improve the durability of the via holes provided in the via hole installation portion and a connection component related thereto by reducing the load acting on the via hole installation portion. Accordingly, the conductive module according to the present embodiment can not only cover the via hole installation portion with the via hole cover portion to protect the via hole installation portion from the outside, but also protect the via hole installation portion as a result of improvement in durability, and is suitable for protecting the circuit of the circuit conductor component.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a plurality of bus bars that electrically connects a plurality of battery cells arranged in a row along an arrangement direction in a battery module;
a circuit conductor component that includes a circuit conductor for each of the bus bars that electrically connects the bus bar to a battery monitoring unit, the circuit conductor component being formed flat with flexibility;
a housing member that houses the bus bar and the circuit conductor component through an opening; and
a circuit cover member that is assembled to the housing member at an assembly completion position and covers the circuit conductor component from an opening side, wherein
the circuit conductor component includes two main line portions disposed to face each other with a space in a direction orthogonal to the arrangement direction on a same plane, and a circuit collection portion in which the respective circuit conductors of the two main line portions are collected at one place by coupling respective ends in the arrangement direction of the two main line portions,
the circuit collection portion includes a connector connection portion to which a connector is assembled at an end on a side opposite to a two main line portions side, a via hole installation portion provided with a plurality of via holes on the two main line portions side, and a positional deviation absorption portion that absorbs positional deviation in the arrangement direction of the connector with respect to a counterpart connector on a battery monitoring unit side between the connector connection portion and the via hole installation portion,
the circuit cover member includes a cover body that covers the main line portion from a front surface at the assembly completion position, and a via hole cover portion that presses a front surface of the via hole installation portion at the assembly completion position, and intersects the via hole installation portion such that an angle on an inner side of bending with respect to the two main line portions is an obtuse angle, and
the via hole cover portion is inclined at the angle with respect to the cover body.

2. The conductive module according to claim 1, wherein
the housing member includes a facing disposition surface disposed parallel to the via hole cover portion of the circuit cover member at the assembly completion position and facing a back surface of the via hole installation portion between the housing member and the via hole cover portion of the circuit cover member at the assembly completion position, and
when a force acts on an end of the via hole installation portion on a positional deviation absorption portion side from the positional deviation absorption portion side, the back surface of the end is locked to the facing disposition surface.

3. The conductive module according to claim 1, wherein
the cover body is formed in a shape along the arrangement direction,
the via hole cover portion is formed in a cantilever shape inclined at the angle with respect to the cover body, and
the circuit cover member includes a contact protrusion that protrudes from a free end of the via hole cover portion and contacts the housing member at the assembly completion position to dispose the circuit collection portion between the free end of the via hole cover portion and the housing member with a gap between the free end and the housing member.

4. The conductive module according to claim 3, wherein the housing member is provided with a locking protrusion that protrudes to the opening side with respect to the free end of the via hole cover portion at the assembly completion position, locks the positional deviation absorption portion at a tip on a protruding direction side, and bends the positional deviation absorption portion separately to a connector connection portion side and a via hole installation portion side.

5. The conductive module according to claim 1, wherein the circuit cover member is assembled to the housing member along an assembly path orthogonal to the arrangement direction and the facing disposition direction of the two main line portions.

6. The conductive module according to claim 2, wherein the circuit cover member is assembled to the housing member along an assembly path orthogonal to the arrangement direction and the facing disposition direction of the two main line portions.

7. The conductive module according to claim 3, wherein the circuit cover member is assembled to the housing member along an assembly path orthogonal to the arrangement direction and the facing disposition direction of the two main line portions.

8. The conductive module according to claim 4, wherein the circuit cover member is assembled to the housing member along an assembly path orthogonal to the arrangement direction and the facing disposition direction of the two main line portions.
